(19) United States
(12) Patent Application Publication
(10) Pub. No.: US 2017/0248832 A1
(43) Pub. Date: Aug. 31, 2017

(54) Microwave to Optical Conversion Device and Method for Converting a Microwave Photon to an Optical Photon

(71) Applicant: ECOLE POLYTECHNIQUE FEDERALE DE LAUSANNE (EPFL), Lausanne (CH)

(72) Inventors: Tobias Kippenberg, Lausanne (CH); Clement Javerzac-Galy, Lausanne (CH)

(21) Appl. No.: 15/442,730

(22) Filed: Feb. 27, 2017

Related U.S. Application Data
(60) Provisional application No. 62/300,936, filed on Feb. 29, 2016.

(51) Int. Cl. G02F 1/35; G02F 1/365

(52) U.S. Cl. CPC G02F 1/353; G02F 1/365; G02F 1/3501; G02F 1/3534; G02F 2001/354; G02F 2001/3509

(57) ABSTRACT

A microwave to optical conversion device comprising:
a superconducting microwave resonator, and
an optical resonator including an electro-optical material,
the superconducting microwave resonator and the optical resonator being arranged one with respect to the other so as to be electro-magnetically coupled.

### CROSS-REFERENCE TO RELATED APPLICATIONS

The present application claims priority to the Provisional Application with the Ser. No. 62/300,936 that was filed on Feb. 29, 2016, the entire contents thereof being herewith incorporated by reference.

### FIELD OF THE INVENTION

The present invention relates to the field of devices for microwave-to-optical conversion, for example, to an on-chip device architecture capable of direct quantum coherent electro-optical conversion of microwave photons to optical photons. This disclosure also provides a device and system for high efficiency and low-noise detection of single photons within the microwave spectrum.

### DISCUSSION OF THE BACKGROUND ART

A quantum microwave-to-optical converter refers to the quantum coherent interconversion of microwave and optical signals. The interconversion of microwave and optical signals is of practical relevance in a broad range of electronic applications, from optical and wireless communications to timing. The spectacular advances of the past decade in manipulating the quantum states of the microwave field has increased interest in techniques to convert them to optical fields, since the latter can be propagated via optical fiber at room temperature while preserving their quantum state. In the long term, converting quantum states between microwave and optical photons may enable long distance quantum communication, and in the near term, it provides a path towards realizing single photon detectors of the microwave field that may find use in quantum science and metrology and technology alike.

Quantum interfaces, which are of fundamental importance, are those enabling the coherent manipulation and transfer of the quantum state of photons between radically different wavelengths, and in particular between optical and microwave/radiofrequency (rf) photons. Indeed, the reversible conversion of quantum states between microwave and optical photons will enable the distribution of quantum information over long distance and significantly improve the scalability of hybrid quantum systems. Recent years have seen landmark experimental progress using mechanical interfaces.

Hybrid quantum systems refer to systems composed of different physical components with complementary functionalities that together may provide precisely capabilities that exploit the effects of quantum mechanics. They aim at the development of practical technologies, in particular devices for quantum information processing, secure communication, and high precision sensing.

Hybrid systems for such microwave to optical interfaces have recently attracted significant experimental efforts. Several approaches have been investigated: optomechanical and electromechanical devices as well as cold atoms and spin ensembles. Indeed, a bi-directional and efficient link has been established recently using a mechanical oscillator coupled to both optical and microwave modes.

However, the perturbation of the mechanical noise and the intrinsic dissipation of the cavity modes are major obstacles that prevent the realization of quantum state conversion. Several recent proposals suggest the use of other coupling mechanisms that would operate more direct conversion. Nonetheless, technical difficulties are challenging due to the complexity of the proposed systems. Noise sources in the transducers are strong limitations to the operation in the quantum limit. The proposed device has no nanomechanical part. Proposed direct converters (without mechanical elements) do not provide an architecture with high enough coupling for quantum coherent operation. No quantum coherent device is of reach with current proposals. For such operation, the interaction requires large vacuum coupling rates and the resolved-sideband regime to be efficient as well as an optical cavity decay rate that greatly exceeds the microwave decay rate.

### SUMMARY

It is therefore one aspect of the present disclosure to provide a conversion device that overcomes the above challenges. The conversion device preferably includes a superconducting microwave resonator, and an optical resonator including an electro-optical material. The superconducting microwave resonator and the optical resonator are arranged one with respect to the other so as to be electro-magnetically coupled.

According to another aspect of the present disclosure, the superconducting microwave resonator includes a first electrode and a second electrode defining an electro-magnetic coupling zone there-between, the optical resonator being located at least partially in said electro-magnetic coupling zone.

According to yet another aspect of the present disclosure, the first electrode, the second electrode and the optical resonator are arranged in an overlapping arrangement.

According to a further aspect of the present disclosure, the optical resonator is a whispering-gallery-mode optical resonator.

According to a another aspect of the present disclosure, the electro-optical material has a second order χ⁽²⁾ optical non-linearity or a third order χ⁽³⁾ optical non-linearity.

According to yet another aspect of the present disclosure, the electro-optical material has a high electro-optic coefficient, high refractive index and a low microwave dielectric constant.

According to a further aspect of the present disclosure, the optical resonator is embedded in an insulating or dielectric material. According to yet another aspect of the present disclosure, the superconducting microwave resonator is coupled to a microwave feed line and the optical resonator is coupled to an optical waveguide.

According to a another aspect of the present disclosure, the optical resonator is a planar microresonator and the superconducting microwave resonator is a superconducting microstrip resonator.

According to yet another aspect of the present disclosure, the optical resonator is a planar ring-resonator and the superconducting microwave resonator is a planar superconducting microstrip resonator.

According to a further aspect of the present disclosure, the planar superconducting microwave resonator includes a first planer electrode and a second planar electrode located above and below the planar ring-resonator, and the optical planar ring-resonator extends in a plane substantially parallel to the plane of the first and second planar electrodes.

According to a another aspect of the present disclosure, the first planar electrode of the superconducting microwave resonator defines a ring structure and includes a spacer to define a discontinuous ring.

According to yet another aspect of the present disclosure, the optical resonator is configured to propagate a Transverse Electric optical mode.

According to another aspect of the present disclosure, the optical resonator is configured to propagate two optical modes spaced by the microwave resonance frequency of the microwave resonator.

According to a further aspect of the present disclosure, the electro-optical material includes lithium niobate, aluminum nitride, lithium tantalite, gallium phosphide, gallium arsenide, barium titanate; and the superconducting microwave resonator includes titanium nitride.

According to another aspect of the present disclosure, the superconducting microwave resonator and the optical resonator form an on-chip integrated device.

It is another aspect of the present disclosure to provide a method for converting a microwave photon to an optical photon that overcomes the above challenges. The method includes the steps of providing the above mentioned microwave to optical conversion device; and performing a three-wave mixing among a microwave signal and two optical signals in the optical resonator.

Another aspect of the present disclosure concerns an array including a plurality of microwave to optical conversion devices.

Another aspect of the present disclosure concerns a single photon detector including at least one microwave to optical conversion device.

With the proposed device of the present disclosure, the above mentioned two requirements of the interaction requiring large vacuum coupling rates and the resolved-sideband regime being efficient are fulfilled by coupling the electric field of a superconducting resonator to an optical microresonator made from an electro-optical material, for example, a whispering-gallery-mode (WGM) microresonator.

Second-order nonlinear materials can be used. Third-order nonlinear materials can be used to implement tuneable and enhanced nonlinear interaction.

The device of the present invention proposes the first on-chip implementation, providing the possibility for embedded systems and scalability. The fabrication of electro-optical arrays is possible. A fibre-based device is also possible. The disclosed device and method will enable new regimes for radio- and microwave electromagnetic field detection, and allow quantum-limited amplification and readout of microwave and radio-frequency radiation. At the same time solid-state quantum devices which are now mainly manipulated by radiofrequencies and/or microwaves will become efficiently coupled to and controlled by optical fields.

The above and other objects, features and advantages of the present invention and the manner of realizing them will become more apparent, and the invention itself will best be understood from a study of the following description with reference to the attached drawings showing some preferred embodiments of the invention.

### A BRIEF DESCRIPTION OF THE SEVERAL VIEWS OF THE DRAWINGS

FIG. 1A shows the principle of the present disclose for a cavity electro-optical system for microwave-to-optical conversion, constituted of a χ⁽²⁾ (or χ⁽³⁾) WGM microresonator resonant at ωₐ coupled to a waveguide with an external coupling rate κₐ^{(ex)} and of intrinsic loss rate κₐ⁽ⁱⁿ⁾, and an LC microwave circuit, resonant at ω_{b} coupled via a feedline (for instance capacitively or inductively coupled) with an external coupling rate κ_{b}^{(ex)}, where d is the distance between the microwave resonator electrodes and l is the length of the optical path;

FIG. 1B shows, in the resolved sideband limit, that the system enables via lower sideband pumping at ωₚ=ωₐ−ω_{b} to laser cool the microwave photons, i.e. up-convert them to the cold optical mode, establishing a coherent interface between microwave and optical fields; to minimize required optical input power it is possible to match the microwave resonance frequency ω_{b} to the optical free spectral range (FSR);

FIG. 2 shows a schematic view of an exemplary quantum coherent electro-optical conversion system proposed for up-converting microwave photons to the optical domain, where the upper portion depicts a top view and the lower portion shows a cross-sectional view; the optical cavity is a microring resonator made out of for example z-cut LiNbO3 coupled via a waveguide by evanescent-field coupling, the microwave cavity is a λ/2 microstrip resonator, the resonator is overlapped with the optical microring to maximize the mode overlap and thus the electro-optic coupling, the symmetry of the microwave resonator is broken, for example by grounding its ends, to ensure that only the positive phase of the microwave electric field profile couples to the optical microresonator, the microwave cavity is capacitively (or inductively) coupled to a microstrip feedline;

FIG. 3A shows 2D FEM simulations of an optimized device geometry and an optical energy density profile of an optical WGM mode in a lithium niobate resonator with ωₐ=2π·200 THz, the refractive index contrast between the LiNbO₃ WGM and the surrounding SiO₂ provides high confinement of the optical energy;

FIG. 3B shows 2D FEM simulations of an optimized device geometry and the electric potential and electric field (arrows) across the electrodes inside the microwave cavity at ω_{b}=2π·6 GHz, the direction and amplitude of the field are optimized to maximize g₀ and d is the distance between the electrodes, plots are on log scale with the map given on the right in arbitrary units;

FIG. 4A through to FIG. 4D show alternative geometries and other types of planar superconducting cavities (microstrip or CPW) and planar optical cavities; where FIG. 4A shows a device with a λ/2 microstrip cavity ensuring maximal positive interaction between the optical and microwave fields; FIG. 4B shows an alternative geometry using a coplanar waveguide (CPW) planar superconducting cavity, the positive phase of the large vacuum electric field of the CPW couples to the optical field on half of the CPW; FIG. 4C shows a geometry in which the positioning of the microstrip cavity selects only one half of the total field, maximizing the overlap with the positive phase; FIG. 4D shows a geometry using a racetrack microresonator, the total length of the optical resonator can be changed while optimizing the footprint of the device, the overlap with the planar superconducting resonator is controlled by the interaction length with the optical microresonator;

FIG. 5 shows a table including parameters and results for different geometries in LiNbO₃, including G1: electrodes on the side of WGM (optimized distance d˜1.5 μm, as in FIG. 3), G2: electrodes on top and bottom of WGM (not optimized distance), G3: electrodes on top and bottom of WGM (optimized distance), G4: electrodes on top and bottom of WGM (optimized distance and polarization), but axial polarization of Ea (instead of radial), parameters are computed for realistic experimental parameters: ωₐ/2π=200 THz, ω_{b}/2π=6 GHz, Qₐ≈10⁵ and Q_{b}≈10³.

Herein, identical reference numerals are used, where possible, to designate identical elements that are common to the figures.

### DETAILED DESCRIPTION OF THE SEVERAL EMBODIMENTS

The present disclosure concerns a conversion device, for example, an on-chip microwave-to-optical quantum coherent converter based on an integrated superconducting resonator coupled to an integrated electro-optic microresonator.

A device architecture capable of direct and efficient quantum electro-optical conversion is disclosed. The scheme uses three-wave mixing that takes place in an integrated optical microresonator, for example, made out of a thin-film nonlinear crystal coupled to the electric-field of a superconducting microwave integrated resonator. A high fidelity conversion of quantum states can be reached. The salient features of the device enable high-coupling rates and scalability (on-chip). The absence of a transducer allows quantum coherent operation.

The present disclosure also relates a method for conversion enabling low optical pump power. This, combined with the use of photonic couplers, enables a fiber-based detector or device. A dual mode scheme allows a conversion efficiency close to unity with low power. Quanta of noise introduced are minimal, as low as 2n+1 for strongly over-coupled resonators. This makes the device a compact microwave single-photon detector with good reliability.

In some embodiments, the present disclosure relates to optical microresonators, such as microrings or photonic crystals. These microresonators are on-chip. They are fabricated with standard microfabrication techniques. They do not require specific polishing steps as is the case for some whispering-gallery-mode crystalline bulk resonators. This type of device is thus scalable, has small footprint and is fully monolithic. It also provides large confinement, large overlap with the microwave field and thus large coupling required for quantum operation.

Thin-film crystalline electro-optic materials are used, such as Lithium Niobate On Insulator (LNOI) or Thin Film Lithium Niobate (TFLN) in the case of Lithium Niobate. This allows for the integration of the optical part of the device. The direct coupling of the microwave and optical fields is achieved using Pockel's effect χ⁽²⁾ nonlinearity.

In some embodiments, third-order χ⁽³⁾ nonlinear materials are used for the optical microresonator. It allows to implement an electrically (voltage dependent) tuneable and enhanced second-order nonlinear interaction needed for the conversion. It uses the ability to tune the effect by a DC-bias and thus enhance the nonlinear interaction with an external voltage. In this case the electric-field-induced second-order nonlinearity can be higher than the natural second-order nonlinearity of electro-optic materials. This increases the electro-optical coupling. It also has the advantage of preventing piezoelectric parasitic effects due to the intrinsic origin of the third-order nonlinearity.

The device of the present disclosure couples planar superconducting cavities to the planar optical microresonator. The electric field couples to the optical mode via the electro-optical effect. This design does not require the use of 3D superconducting cavities or direct coupling to superconducting qubits. 2D superconducting resonators feature small microwave mode volume, high resonance frequencies and high quality factors. They allow for the large coupling in the device of the present disclosure.

The monolithic nature of the device of the present disclosure prevents any piezoelectric spurious effect that could spoil the conversion. The optical cavity is preferably embedded in an insulating layer. It also prevents any mechanical parasitic effect. The low index of the insulating layer also enhances the confinement of microwave and optical fields in the coupling area to maximize the coupling. It also enables scalability of the device into electro-optic arrays, either for an array of single-photon detectors or for quantum simulations/computations in quantum network applications.

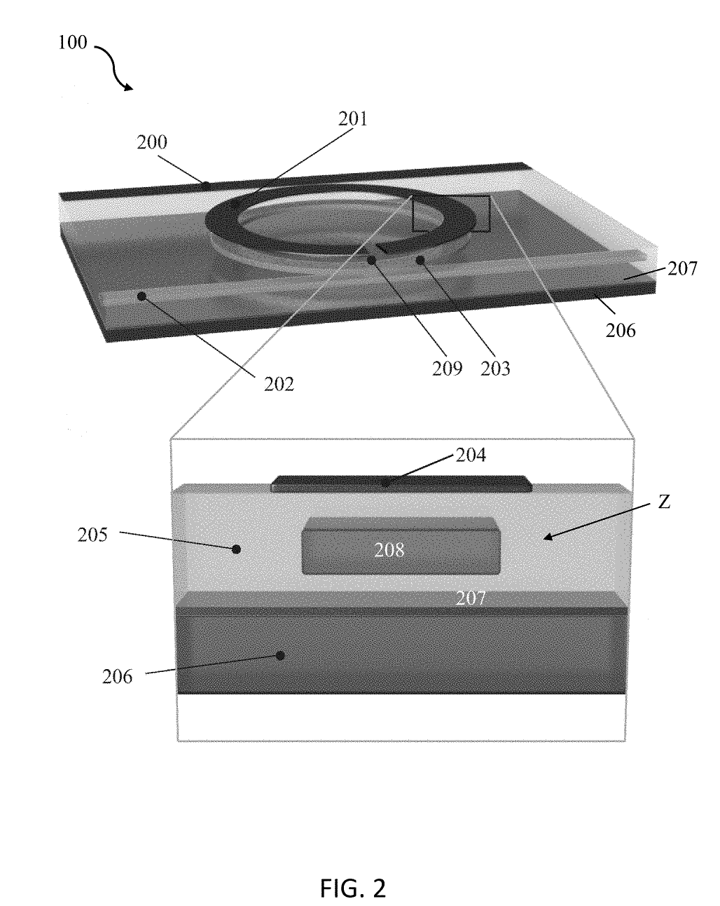

FIG. 2 shows one aspect of the present disclosure, depicting a conversion device 100. This conversion device 100 comprises a superconducting microwave resonator 201, and an optical resonator 203, 208 including an electro-optical material. The superconducting microwave resonator 201 and the optical resonator 203, 208 are arranged one with respect to the other so as to be electro-magnetically coupled.

The superconducting microwave resonator 201 includes a first electrode or metal top electrode 204 and a second electrode or metal ground plate 207 defining an electro-magnetic coupling zone Z there-between. The first electrode 201 is superposed on or overlays the second electrode 207. The first 201 and second electrodes 207 are spaced apart by a spacing layer 205. An area under the first electrode 204 and between the first and second electrode defines the electro-magnetic coupling zone Z. The optical resonator 203. 208 is preferably located at least partially or fully in the electro-magnetic coupling zone Z. The first electrode 201, the second electrode 207 and the optical resonator 203, 208 are positioned one with respect to the other in an overlapping arrangement as can be seen, for example, in FIG. 2. in an insulating or dielectric material.

Spacing layer 205 preferably comprises or consists solely of insulating or dielectric material 205. The optical resonator 203, 208 is embedded in the insulating or dielectric material.

The superconducting microwave resonator 201 is coupled to a microwave feed line 200 and the optical resonator 203, 208 is coupled to an optical waveguide 202.

The optical resonator 203, 208 is preferably a planar microresonator and the superconducting microwave resonator is preferably a planar superconducting microstrip resonator or coplanar waveguide resonator. The optical resonator 203, 208 is, for example, a planar ring-resonator and the superconducting microwave resonator 201 is, for example, a planar superconducting microstrip resonator. The first 204 and second 207 electrodes are preferably planar electrodes and the first planar electrode 204 and the second planar electrode 207 are located above and below the planar ring optical resonator 203, 208. The first electrode 204 extends, for example, to define a ring structure. The first electrode 204 preferably includes a spacer 209 or discontinuation in the electrode and defines a discontinuous ring. The second electrode 207, for example, extends to define a continuous planar ground-plane electrode. The planar ring optical resonator 203, 208 extends in a plane substantially parallel to the plane of the first and second planar electrodes.

The optical resonator 203, 208 is, for example, a whispering-gallery-mode (WGM) optical resonator. The electro-optical material has a second order χ⁽²⁾ optical non-linearity or a third order χ⁽³⁾ optical non-linearity. An electric field applied to the third order χ⁽³⁾ electro-optical material, for example via the first and second electrodes, produces an electric-field induced second order non-linearity in the electro-optical material that can be tuned and be higher than that present in natural second order χ⁽²⁾ electro-optical material. The device 100 converts microwave photons to optical photons via three-wave mixing among a microwave signal and two optical signals in the optical resonator. The electro-optical material includes lithium niobate or lithium tantalate or aluminum nitride or gallium phosphide or gallium arsenide or barium titanate or various niobates, phosphates, borates, arsenides and selenides, or the superconducting microwave resonator includes titanium nitride.

The optical resonator 203, 208 can, for example, be configured to propagate a Transverse Electric optical mode. The optical resonator 203, 208 can be configured to propagate two optical modes spaced by the microwave resonance frequency of the microwave resonator.

The substrate 206 can comprise or consist solely of silicon, silica, sapphire, or glass. The substrate 206 can also comprise or consist solely of lithium niobate or lithium tantalate or aluminum nitride or gallium phosphide or gallium arsenide or barium titanate or various niobates, phosphates, borates, arsenides and selenides.

The operation of the converter 100 uses the fact that the electro-optical interaction is formally equivalent to the optomechanical Hamiltonian, whereby the microwave field plays the role of the mechanical degree of freedom. Consequently, in the good cavity limit (resolved sideband regime), pumping the system with an optical laser on the lower sideband, will in the linearized regime lead to a beam-splitter interaction Hamiltonian

Ĥ=g₀(â\hat{b}^{†}+â^{†}\hat{b})

which effectively sideband cools the microwave mode, i.e. converts the microwave state to an optical photon at frequency ωₚ+ω_{b}. For the case of a zero temperature bath and a pulsed optical cooling field, the input state of the microwave field and the optical field are swapped and state transfer achieved. While electro-optical materials have been widely employed in modern optical telecommunication, realizing the conversion scheme in this manner has been challenging due to the inability to achieve large overlap of the microwave and optical field, resulting in insufficient coupling rates.

For an integrated WGM microresonator coupled to an equivalent LC circuit the electro-optic coupling coefficient can be expressed as

$${g}_{0} = {ω}_{a} {n}^{2} r \sqrt{\frac{\overline{h} {ω}_{b}}{{ɛ}_{0} {ɛ𝒱}_{b}} ,}$$

where the only geometrical parameter is the microwave mode volume V_{b}. Therefore, to attain a large vacuum coupling rate g₀, a large overlap of the electric field distribution and the optical mode of the cavity has to be attained. This formula also emphasizes that a material with high electro-optic coefficient r, high refractive index n and low microwave dielectric constant are preferable. Exemplary materials include: lithium niobate (LiNbO₃) or lithium tantalate (LiTaO₃) or aluminum nitride or gallium phosphide or gallium arsenide or barium titanate or various niobates, phosphates, borates, arsenides and selenides etc. . . . .

Third order nonlinear materials can be used, such as silicon nitride SiN₃O₄. This realizes the implementation of an electrically (voltage-dependent) tuneable and enhanced second-order nonlinear interaction. It uses the ability to tune the effect by a DC-bias and thus enhance the nonlinear interaction with an external voltage. In this case the electric-field-induced second order nonlinearity can be higher than the natural second-order nonlinearity of electro-optic materials. This increases the electro-optical coupling. It also has the advantage of preventing piezoelectric parasitic effects due to the intrinsic origin of the third-order nonlinearity. An external DC-source coupled via a bias-T to the same electrodes generates high direct current electric field across the nonlinear material. With integrated device as in the invention, only low voltage is sufficient to obtain the effect E_{DC} χ₍₃₎≧χ₍₂₎. The device 100 of the present disclosure is in turn an integrated on-chip controllable device.

To enable sizeable electro-optical coupling to an integrated nonlinear optical microresonator on the same chip, the proposed new underlying hybrid device architecture uses the large vacuum electric field offered by 2D superconducting resonators, which confine electromagnetic modes to small volume V_{b}<<λ³ and commonly exhibit high-Q. Indeed, titanium nitride TiN resonators can attain quality factors as high as Q_{b}˜10⁷ at millikelvin temperatures. The disclosed on chip, integrated device is based, for example, on an optical WGM microring resonator 203, 208 made from a material that features χ⁽²⁾ nonlinearity, such as lithium niobate (LiNbO₃) or aluminium-nitride (AlN).

As shown schematically in FIG. 2, the planar microresonator is coupled to a superconducting microstrip resonator, whose electric field couples to the optical mode via the electro-optical effect. The fabrication of microresonators from electro-optical materials is made possible via crystalline LiNbO₃ thin films (such as Lithium Niobate On Insulator), which allow to combine the large on-chip element density of integrated photonics with the second-order nonlinearity of LiNbO₃. Microresonators with Q of 10⁶ have been demonstrated with this material.

Because of the absence of a symmetry centre, nonlinear χ⁽²⁾ materials also exhibit piezoelectricity, which can cause modulation of the optical field and perturb the electro-optic modulation via the Pockels effect. By design, the exemplary LiNbO₃ microring is embedded in, for example, silica (SiO₂) and thus is clamped. Hence, the mechanical degree of freedom is frozen and the piezoelectric contribution to the modulation made negligible. This result can be verified by a simulation comparing a suspended microdisk and an embedded microring of the same geometries under the same microwave excitation. For the latter, the piezoelectric coupling strength is more than 9 orders of magnitude smaller and therefore can be neglected.

The exemplary device and simulation efforts focused on Z-cut LiNbO₃. LiNbO₃ exhibits a r₅₁ as high as 30 pm·V⁻¹. Nanofabrication platforms are also mature enough to provide good structures with thin-film single crystals. Numerical simulations were conducted in order to take into account the anisotropy of the material and the complex geometry of our design. More details of these numerical simulations can be found in the publication ‘On-chip microwave-to-optical quantum coherent converter based on a superconducting resonator coupled to an electro-optic microresonator’, by C. Javerzac-Galy, K. Plekhanov, N. R. Bernier, L. D. Toth, A. K. Feofanov, and T. J. Kippenberg published in Phys. Rev. A 94, 053815 (2016) and in the arXiv.org database arXiv:1512.06442, the entire contents of which is herein incorporated by reference.

Therefore, taking into account the geometry and the anisotropy of the system, the expression of the electro-optical coupling coefficient becomes

$${g}_{0} = \frac{{ω}_{a} {ɛ}_{0}}{2 {U}_{a} V} \sqrt{\frac{\overline{h} {ω}_{b}}{2 C}} {\int }_{𝒱} {ɛ}_{ik} \cdot {ɛ}_{jl} \cdot {r}_{klm} \cdot {E}_{b}^{m} {E}_{a}^{i} {E}_{a}^{j} d 𝒱 .$$

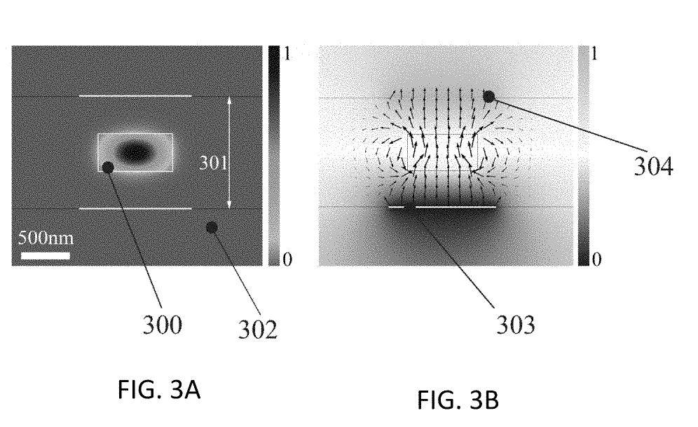

An optimization of the different parameters, such as position and size of the microwave microstrip or polarization, was run in order to maximize g₀. In particular, one can extract that TE optical modes characterized by high axial components Dₗ^{z} give higher coupling. For the geometry illustrated in FIG. 3, we compute g₀˜2π·50 kHz at 2200 THz (i.e. λₐ≈1550 nm) at ωₐ=2π·200 THz and ω_{b}=2π·6 GHz with d≈1.5 μm.

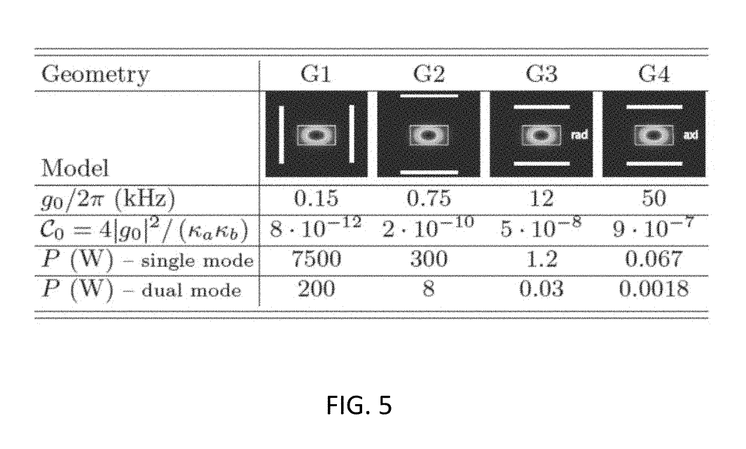

The position of the electrodes is critical for best results. Electrodes on top (as in FIG. 3) prove to give higher coupling and are more convenient for fabrication (compared to electrodes on the side of the optical WGM, with similar distance to the WGM). The distance d between the electrodes is key to providing high-confinement of the field. However, it must be kept in mind as well that the quality factors of both optical and microwave cavities depend on the geometry. For instance, no metal should directly be too close to the evanescent field of the optical waveguide fields. For geometries G1 to G4 in FIG. 5, the field energy density at the position of the electrodes is 6 orders of magnitude smaller than that at the centre of the mode, and therefore absorption is strongly reduced. Parameters and results are detailed in the table of FIG. 5 for different optimum geometries.

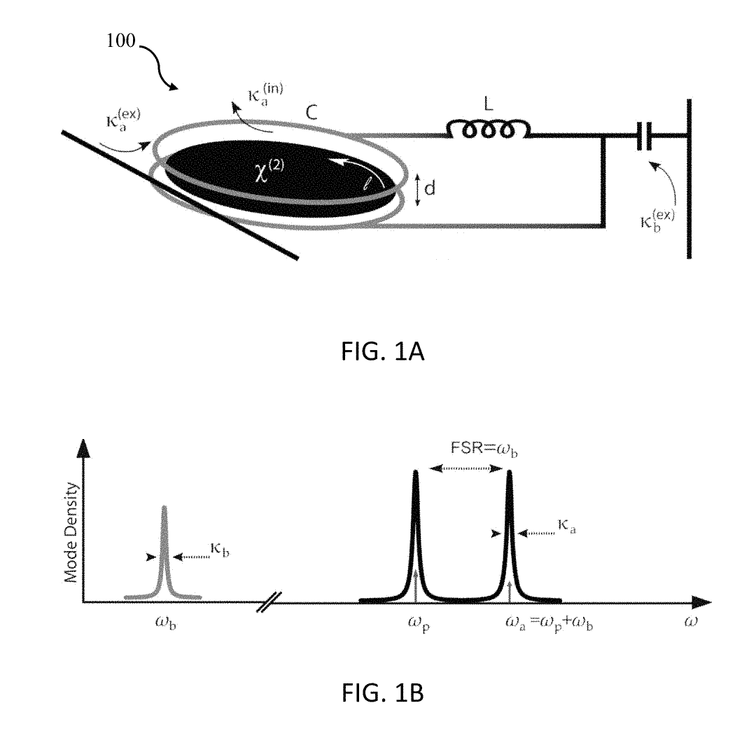

By pumping the lower sideband of the hybrid electro-optical system at ωₚ=ωₐ−ω_{b} (see FIG. 1), the microwave photons are laser cooled, i.e. up-converted to the cold optical mode. If the microwave cavity is already cooled to the ground state by passive cooling, which is easily achieved in the case of superconducting cavity with GHz resonance frequency cooled to the base temperature of a dilution refrigerator, this up-conversion may be used to establish a coherent interface between microwave and optical fields. The converter 100 would work at ω_{b}=2π·6 GHz, a typical frequency of microwave superconducting qubits, and 10 mK to assure the microwave cavity ground state.

The main objective of the device 100 is to achieve quantum coherent microwave-to-optical frequency conversion: to achieve near-complete frequency conversion (i.e., near-unity quantum efficiency γ˜1), the extrinsic decay rate of the optical cavity should dominate the intrinsic one, such that the frequency up-converted microwave photon leaves the optical cavity before it decays; the microwave cavity should be strongly overcoupled as well. The overall intrinsic efficiency of the frequency up-conversion process, defined by the efficiency of converting microwave to optical quanta, can be calculated as

$$γ [ ω ] = \frac{{κ}_{a}^{( ex )}}{{κ}_{a}} \frac{{κ}_{b}^{( ex )}}{{κ}_{b}} \frac{4 𝒞}{{( 1 + 𝒞 )}^{2}} \frac{1}{1 + \frac{{( {ω}_{b} - ω )}^{2}}{{{κ}_{b}^{2} ( 1 + 𝒞 )}^{2} / 4}}$$

thus the overall efficiency is a function of frequency and cooperativity C, which is proportional to the number of photons in the optical cavity

$$𝒞 = {\overline{n}}_{p} \cdot {𝒞}_{0} where$$

$${𝒞}_{0} = \frac{4 {\vert {g}_{0} \vert}^{2}}{{κ}_{a} {κ}_{b}}$$

is the electro-optical single-photon cooperativity. Interestingly, when ω=ω_{b}, a cooperativity of C=1 is sufficient to obtain the maximum efficiency, making achievable the complete photon conversion between microwave and optical fields on a chip.

The quantum-state-transfer is only possible if a unity cooperativity is achieved and the coupling strength is much larger than the microwave decay rates κ_{b}, i.e.

2g₀\sqrt{n̅ₚ}>>_{b}.

When implementing the converter 100 with a single optical resonance (see Table of FIG. 5) the required power levels are of the order of 100 milliwatts or even higher, making a realistic implementation difficult. The power can however be substantially reduced by employing two optical modes (see FIG. 1B), spaced by the microwave frequency (i.e. a multiple cavity mode transducer). In this case, when the free spectral range matches the microwave frequency, one has

$${\overline{n}}_{p} = \frac{P}{\overline{h} {ω}_{a} {κ}_{a}}$$

where P is the optical pump power. With such a dual mode design, the pump power required to obtain C=1 is

P=ωₐκₐC₀⁻¹

and can be as low as O(1)mW with conservative parameters slightly better than Qₐ≈10⁵ and Q_{b}≈10³. Thus according to expression

$$γ [ ω ] = \frac{{κ}_{a}^{( ex )}}{{κ}_{a}} \frac{{κ}_{b}^{( ex )}}{{κ}_{b}} \frac{4 𝒞}{{( 1 + 𝒞 )}^{2}} \frac{1}{1 + \frac{{( {ω}_{b} - ω )}^{2}}{{{κ}_{b}^{2} ( 1 + 𝒞 )}^{2} / 4}}$$

a conversion efficiency exceeding 90% can be achieved with O(1)mW of pump power with the disclosed device design. In contrast to the realization with the only optical mode, in the dual-optical-mode scheme the required power does reduce when Qₐ increases. For instance, for the state-of-the-art parameters of Qₐ≈10⁶ and Q_{b}≈10⁴, one would need O(1)μW of optical power only.

The noise introduced by the coupling of modes other than the incoming microwave signal limits the quantum fidelity of the microwave to optical photon conversion. We theoretically characterized the noise added during the conversion process by the equivalent quanta of the total noise, as compared to the spectral density of the input signal. On resonance, we find that

$${n}_{eq} = \frac{{κ}_{b}}{{κ}_{b}^{( ex )}} ( 2 {\overline{n}}_{el , th} + \frac{{( 1 + 𝒞 )}^{2}}{4 𝒞} \frac{{κ}_{a}}{{κ}_{a}^{( ex )}} )$$

quanta of noise are introduced, with

n̅_{el,th}

the thermal occupation of the microwave mode.
The first term gives the noise contribution from the microwave, and the second from the optical degrees of freedom. For strongly over-coupled resonators, one would only add

n_{eq}=2n̅_{el,th}+1.

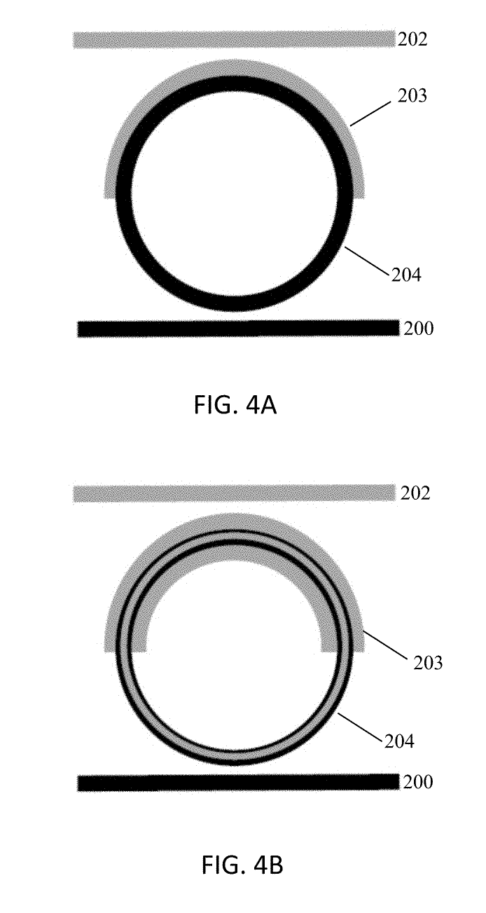

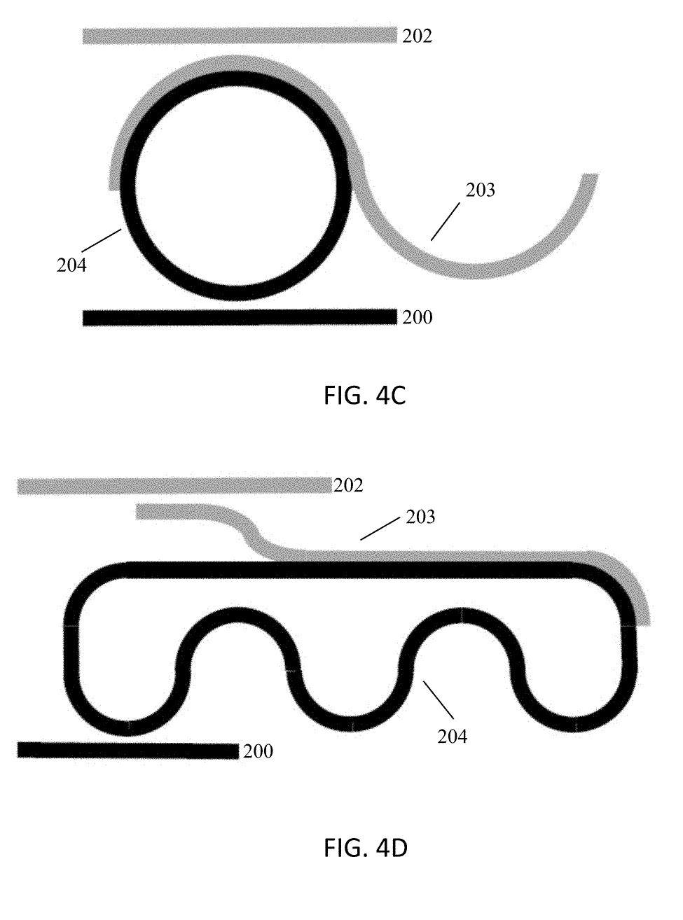

FIGS. 4A to 4D schematically shows alternative exemplary structures and configurations of the superconducting microwave resonator and optical resonator of the device 100 of the present disclosure, in particular, the first electrode 204. FIG. 4A shows a device with a λ/2 microstrip cavity ensuring maximal positive interaction between the optical and microwave fields. FIG. 4B shows an alternative geometry using a coplanar waveguide (CPW) planar superconducting cavity where the positive phase of the large vacuum electric field of the CPW couples to the optical field on half of the CPW. FIG. 4C shows a geometry in which the positioning of the microstrip cavity selects only one half of the total field, maximizing the overlap with the positive phase. FIG. 4D shows a geometry using a racetrack microresonator. The total length of the optical resonator can be changed while optimizing the footprint of the device. The overlap with the planar superconducting resonator is controlled by the interaction length with the optical microresonator.

The present disclosure thus concerns a device architecture capable of direct quantum electro-optical conversion of microwave to optical photons. The hybrid system includes, for example, a planar superconducting microwave circuit coupled to an integrated whispering-gallery-mode optical microresonator made from an electro-optical material. Large electro-optical (vacuum) coupling rates are provided due to the small mode volume of the planar microwave resonator. Such a converter can enable high efficiency conversion of microwave to optical photons. Noise analysis shows that maximum conversion efficiency can be achieved for a multi-photon cooperativity of unity which can be reached at low optical power.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

### REFERENCE NUMBERS

100 Converter device
200 Microwave feed line
201 Superconducting microwave resonator
202 Optical waveguide
203 Optical resonator
204 Electrode
205 Spacing layer
206 Substrate
207 Electrode
208 Optical resonator
209 Spacer/discontinuity
300 Optical resonator
301 Distance d between electrodes
302 Converter device
303 Electrode
304 Electrode

1. Microwave to optical conversion device comprising:
a superconducting microwave resonator, and
an optical resonator including an electro-optical material,
the superconducting microwave resonator and the optical resonator being arranged one with respect to the other so as to be electro-magnetically coupled.

2. Microwave to optical conversion device according to claim 1, wherein superconducting microwave resonator includes a first electrode and a second electrode defining an electro-magnetic coupling zone there-between, the optical resonator being located at least partially in said electro-magnetic coupling zone.

3. Microwave to optical conversion device according to claim 2, wherein the first electrode, the second electrode and the optical resonator are arranged in an overlapping arrangement.

4. Microwave to optical conversion device according to claim 1, wherein the optical resonator is a whispering-gallery-mode optical resonator.

5. Microwave to optical conversion device according to claim 1, wherein the electro-optical material has a second order χ⁽²⁾ optical non-linearity or a third order χ⁽³⁾ optical non-linearity.

6. Microwave to optical conversion device according to claim 1, wherein the electro-optical material has a high electro-optic coefficient, high refractive index and a low microwave dielectric constant.

7. Microwave to optical conversion device according to claim 1, wherein the optical resonator is embedded in an insulating or dielectric material.

8. Microwave to optical conversion device according to claim 1, wherein the superconducting microwave resonator is coupled to a microwave feed line and the optical resonator is coupled to an optical waveguide.

9. Microwave to optical conversion device according to claim 1, wherein the optical resonator is a planar microresonator and the superconducting microwave resonator is a superconducting microstrip resonator.

10. Microwave to optical conversion device according to claim 9, wherein the optical resonator is a planar ring-resonator and the superconducting microwave resonator is a planar superconducting microstrip resonator.

11. Microwave to optical conversion device according to claim 10, wherein the planar superconducting microwave resonator includes a first planer electrode and a second planar electrode located above and below the planar ring-resonator, the optical planar ring-resonator extending in a plane substantially parallel to the plane of the first and second planar electrodes.

12. Microwave to optical conversion device according to claim 11, wherein the first planar electrode of the superconducting microwave resonator defines a ring structure and includes a spacer to define a discontinuous ring.

13. Microwave to optical conversion device according to claim 1, wherein the optical resonator is configured to propagate a Transverse Electric optical mode.

14. Microwave to optical conversion device according to claim 1, wherein the optical resonator is configured to propagate two optical modes spaced by the microwave resonance frequency of the microwave resonator.

15. Microwave to optical conversion device according to claim 1, wherein the electro-optical material includes lithium niobate, aluminum nitride, lithium tantalite, gallium phosphide, gallium arsenide, barium titanate; and the superconducting microwave resonator includes titanium nitride.

16. Microwave to optical conversion device according to claim 1, wherein the superconducting microwave resonator and the optical resonator form an on-chip integrated device.

17. Array including a plurality of microwave to optical conversion devices according to claim 1.

18. Single photon detector including at least one microwave to optical conversion device according to claim 1.

19. Method for converting a microwave photon to an optical photon comprising the steps of:
providing a microwave to optical conversion device according to claim 1; and
performing a three-wave mixing among a microwave signal and two optical signals in the optical resonator.
